(19) United States
(12) Patent Application Publication
(10) Pub. No.: US 2014/0195606 A1
(43) Pub. Date: Jul. 10, 2014

(54) IDENTIFYING VALUABLE USERS IN A SOCIAL NETWORK

(71) Applicant: AT&T INTELLECTUAL PROPERTY I, L.P., Atlanta, GA (US)

(72) Inventors: Balachander Krishnamurthy, New York, NY (US); Alan Edward Mislove, West Roxbury, MA (US)

(73) Assignee: AT&T Intellectual Property I, L.P., Atlanta, GA (US)

(21) Appl. No.: 13/737,723

(22) Filed: Jan. 9, 2013

(51) Int. Cl. H04L 29/08

(52) U.S. Cl. CPC H04L 67/22
USPC 709/204

(57) ABSTRACT

A method, computer readable medium and apparatus for determining a value of a user of a social network are disclosed. For example, the method measures user influence information of the user on the social network. The method then calculates the value of the user based upon the user influence information.

The present disclosure relates generally to communication networks and, more particularly, to methods and apparatuses for calculating a value of a user in a social network.

### BACKGROUND

Many of today's Online Social Networks (OSNs) monetize advertisements that are displayed to users while browsing the Online Social Network website, with advertisements targeted to the users based on profile data, friendships and user activity. The primary metric for the effectiveness and value in the online advertising industry remains CPM (cost per mille, or cost per thousand impressions that are shown to users). Thus, the more the number of users present on an OSN and higher their level of activity and participation time, the higher the potential for a larger number of impressions for the OSN (and correspondingly higher revenue). However, in many of today's Online Social Networks (OSNs), consisting of hundreds of millions of users, not all users are equally valuable to the OSN.

### SUMMARY

In one embodiment, the present disclosure discloses a method, computer readable medium and apparatus for determining a value of a user of a social network. For example, the method measures user influence information of the user on the social network. The method then calculates the value of the user based upon the user influence information.

### BRIEF DESCRIPTION OF THE DRAWINGS

The teachings of the present disclosure can be readily understood by considering the following detailed description in conjunction with the accompanying drawings, in which:

FIG. 1 illustrates an exemplary system according to embodiments of the present disclosure;

FIG. 2 illustrates a flowchart of a method for determining a value of a user of a social network, according to embodiments of the present disclosure; and

FIG. 3 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses methods, tangible computer-readable media and apparatuses for determining a value of a user of a social network. Although the present disclosure may describe embodiments in the context of particular networks, systems, and environments, the present disclosure is not so limited. Namely, the present disclosure can be applied to any type of computer-based communication network that is capable of supporting communications between devices.

Broadly, a social network is a virtual environment for people to congregate and keep contact with users of the social network. A social network has been defined as a structure made up of individuals or nodes (e.g., representing a person or group of people) and edges, or connections to other nodes based upon various types of relationships (e.g., family, friend, neighbor, business associate, etc.). In the context of the present disclosure, a social network is a formalized online social structure wherein individuals are registered users or members of the social network and define their relationships to other registered users or members via various mechanisms through which an individual can associate his or her profile with the other registered users. For example, a user can associate with other users or may associate with any number of organizations or groups that are defined within the social network. For instance, a user may associate with a university alumni association, a parent-teacher association for a school, a charity, a group of fans of a business or sports team, and the like.

On today's Online Social Networks (OSNs) consisting of hundreds of millions of users, not all users are equally valuable to the OSN. It should be noted that both OSN(s) and operators of OSN(s) (e.g., a corporation or other entities that own and/or operate the OSN via one or more websites, web-servers, etc.) are described herein. Unless specifically indicated, or unless required by the particular context, both the terms OSN and operator of an OSN are intended to be used interchangeably. For many of today's OSNs, profitability is derived from monetizing advertisements that are displayed to users while browsing the site, with advertisements targeted to the users based on profile data, friendships, and user activity. However, despite the plethora of data available, the primary metric in the online advertising industry remains CPM (cost per mille, or cost per thousand impressions that are shown to users). Thus, the more the number of users present on an OSN and higher their level of activity and participation time, the higher the potential for a larger number of impressions for the OSN (and correspondingly higher revenue). For the OSN, users who use the OSN more often are generally more valuable since they will have more advertisement (ad) views, or impressions.

However, the value of a user to the OSN is only partially measured by the user's own associated ad impressions due to the user's own actions. For example, certain users may upload interesting content, and then influence users of the social network to return to the OSN on a regular basis in order to view, reply to, or comment on the content. Thus, in addition to direct impressions that are generated as a user browses an OSN, a user may also generate indirect impressions by enticing friends and other users to return to the OSN. These indirect impressions may lead to even more indirect impressions, as other users return to the site as a result of the friends' activities. All of these direct and indirect impressions may thus enhance the value of a user to the social network in terms of the ability to generate ad impressions and thus generate revenue for the social network and the advertiser(s).

Accordingly, embodiments of the present disclosure more accurately quantify the value of a user of a social network by assessing factors that relate to the direct impressions of the user as well as factors that relate to the indirect impressions that may be generated by the user. The factors that are assessed for quantifying the value of a user of a social network are broadly referred to as “user influence information”. The term “user influence information” includes two broad categories of information: 1) user activity information and 2) user property information. User activity information refers to one or more active activities of the user, whereas user property information refers to one or more properties of the user (e.g., a quality or a trait associated with the user), e.g., the number of friends of the user, the number of indirect impressions brought about by the user, the job title of the user, the professional organizations that the user is a member of, and so on. Thus, user property information does not relate to the actions taken by the user, but instead refers to a quality or a trait associated with the user. It should be noted that user property information will broadly account for even the indirect influence of the user on other users, e.g., as to indirect impressions as discussed below. Examples of user activity information and user property information are disclosed below. However, these examples should not be interpreted as a limitation of the present disclosure. Furthermore, in quantifying the value of a user of a social network using the user influence information, the present method may consider the user activity information and/or the user property information. In other words, the method may consider only the user activity information, only the user property information, or both the user activity information and the user property information.

Examples of different user activities or actions that may lead to different values from the perspective of the OSN may include: providing profile information, “Liking” objects, accepting friend requests, and uploading content. For instance, users who add profile information (e.g., high schools/colleges attended, favorite books/movies, etc.) can enable an OSN to better tailor ads to the user. Likewise, many OSNs allow users to “Like” objects (called “+1” in Google+nomenclature). Such actions provide an OSN with additional information on the user's preferences and also may connect the user to groups of others who like similar objects. Providing demographic information may also allow the OSN to earn more money, as certain demographics are more valuable than others.

Accepting friend requests indicates the connection between the user and another user of the OSN. This enhances an OSN's ability to datamine, and also to make it more likely the user will return to the OSN for updates, e.g., to check for his or her friends' postings and any new uploaded content. Furthermore, a user who uploads content is more likely to return to the OSN, thereby providing the OSN with more opportunities to show advertisement. In addition, the uploading of content is also likely to cause the user's friends to return to the OSN and/or to spend more time on the OSN.

Besides user actions that are indicative of a user's value to an OSN, a number of user properties are also useful in predicting and calculating the user's value. For example, a user's number of friends is indicative of the user's value. To be able to influence others, the user must have a sufficient number of friends to influence them directly. While it is possible that a user with only a few friends can cause cascading activity (i.e., the user can induce friends' activity, which induces friends-of-friends' activity and so on), a user with a higher friend count is likely to have a greater value to an OSN. Determining a user's number of friends may be gleaned from a user profile or the like, which is often made public on the OSN. In any case, such information is likely available to the operator of the OSN even if such information is hidden from other users of the OSN.

Similarly, a user's membership in a greater number of groups or organizations is indicative of a greater value of the user to the OSN. For example, many OSNs also allow users to form groups, and to use these groups as a basis for communication and content sharing. A user who has created or joined many groups is more likely to generate indirect impressions, and therefore be of additional value to the OSN. Similar to the number of friends, the number of group memberships of a user is readily determined. In any case, such group affiliation information is most likely available to the operator of the OSN regardless of whether such information is publicly available to other users.

The participation time of a user on the OSN is yet another indicator of the user's value to the OSN. For instance, the more time the user spends on the OSN, the greater the number of direct impressions of advertisements can be presented. It is possible that a portion of the user's time on the OSN is passive, e.g., when the user remains logged in but walks away from his or her computer for a time. It is however assumed that in general, a greater duration of time on the OSN will involve a greater number of advertisement views, and thus leading to a greater user value. Alternatively, participation time can be expressed in terms of the number of page loads by the user.

Other user properties that may influence user value include a number of OSN-native applications that a user has installed and/or is using. For instance, chat and messaging applications of the OSN are internal applications which generate direct impressions for the user as well as indirect impressions for any other participating users. Similarly, an amount of time that a user spends using such OSN-native applications may be used separately or in conjunction with other factors in order to quantify the value of the user.

In addition, a number of third-party applications that a user has installed, subscribed to and/or is using is also indicative of the user's value. For instance, a user who has a large number of third party applications is likely to generate more impressions (both direct and indirect) than average users. An estimate of the number of impressions generated can be made by examining the applications that the user has installed. Each application can then be paired with the average amount of time the users spend. In one embodiment, a simple threshold can be applied in order to isolate users who generate significant impressions via third-party applications. Some OSNs make available the numbers of OSN-native and third-party applications which are downloaded, installed and/or used by a user. For example, in order to allow interactions via the OSN each third-party and OSN-native application may need to provide information, including which user(s) are using the application. Hence, the OSN may know which users have downloaded and installed which applications.

Furthermore, a user who instigates activities on the OSN, e.g., a user who shows a sustained thread of being an instigator of others' actions is more likely to be a high-value user than a user who only responds to others' actions. For example, an instigating user may upload a photo, thereby triggering comments and status updates from others, which then trigger even more responses. The types of activity that could be instigating activities include status updates, content uploads, third-party application installations, group joining, and so forth. The temporal ordering of activity is easily detected, and activities can sometimes be traced back to the source (e.g., on Facebook, comments are often made on content items or other comments; on Twitter, a tweet can be explicitly marked as a retweet of another's tweet and so on). It should also be noted that a user who provides a response to the user who instigated the initial activity may also be a high-value user. For example, a user's response to a posted video may actually generate a large number of comments from other users, where the comments from the other users are independent of the posted video. In other words, the comments from the other users are simply generated in response to the user's initial response and may not be related to the posted video. In fact, it is possible that the other users may not have even viewed the posted video and are simply reacting to the earlier user's response.

Another user property information that affects a user's value is the recruiting activity of the user. For instance, a user who is responsible for attracting additional users to join the OSN site is also likely to be more valuable to the OSN. This effect can cascade, as the network effect is that the newly recruited users are likely to recruit even more users to join the OSN. Although the ultimate underlying reason for a new user joining an OSN may be indeterminable, the first friend that the new user adds may suggest that the friend was a recruiting user.

In addition to the foregoing, other transient attributes of a user may also cause the user to be more or less valuable to an OSN, depending on the context. For example, users who are located near certain events (conferences, concerts, natural disasters, and the like), who are connected to others of interest (celebrities, objects of news stories), and who have up-to-date information (e.g., about the stock market) are all likely to be more valuable to the OSN. Such information may be useful to the OSN to the extent that it is made available to the OSN. For example, many users interact with the OSN via mobile devices. In addition, in many cases such users permit their devices to provide information to the OSN including their current geographic coordinates and the like.

It should also be noted that different users may have different values to different OSNs. For example, the same user may be a member of two different OSNs, but may have a much greater value to one of the OSNs compared to the other. For instance, the user may be a frequent speaker at business engagements, may have many business contacts (via an OSN that is focused on business networking) and may therefore be a highly valuable user to that OSN. In contrast, the same user may have an average number of friends on a different OSN that is geared more towards keeping in touch with friends, hobbies and personal interests. Thus, the same user may have only an average value to that OSN.

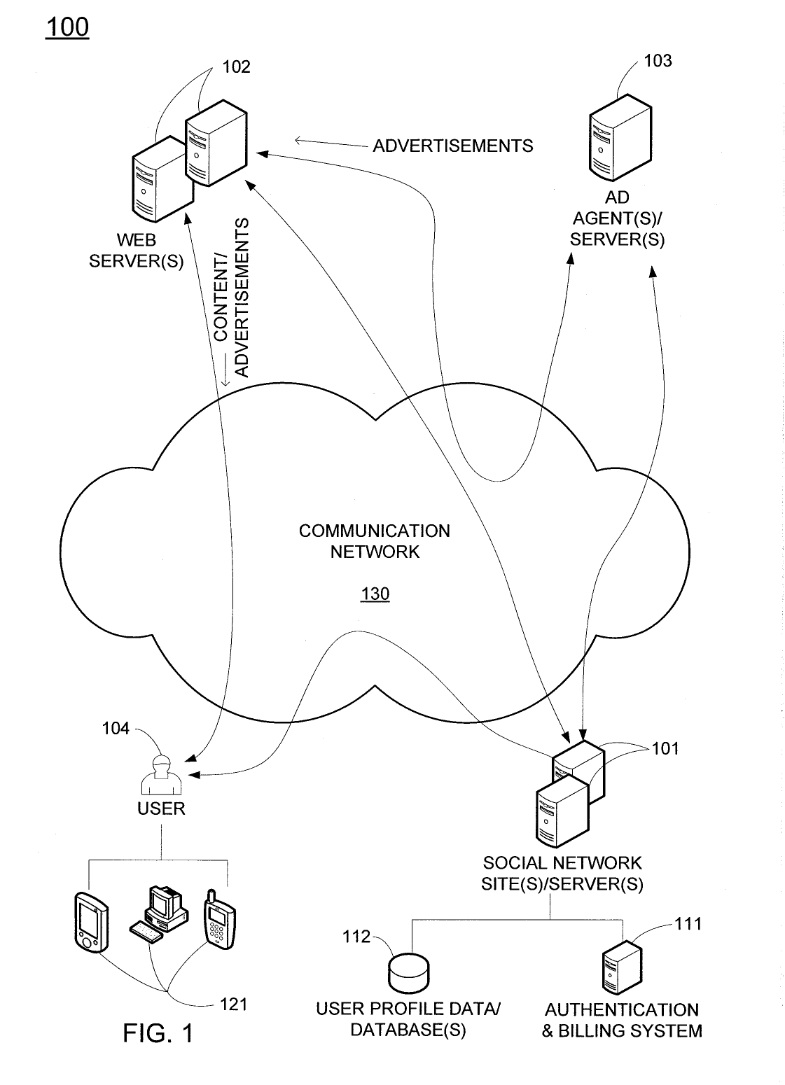

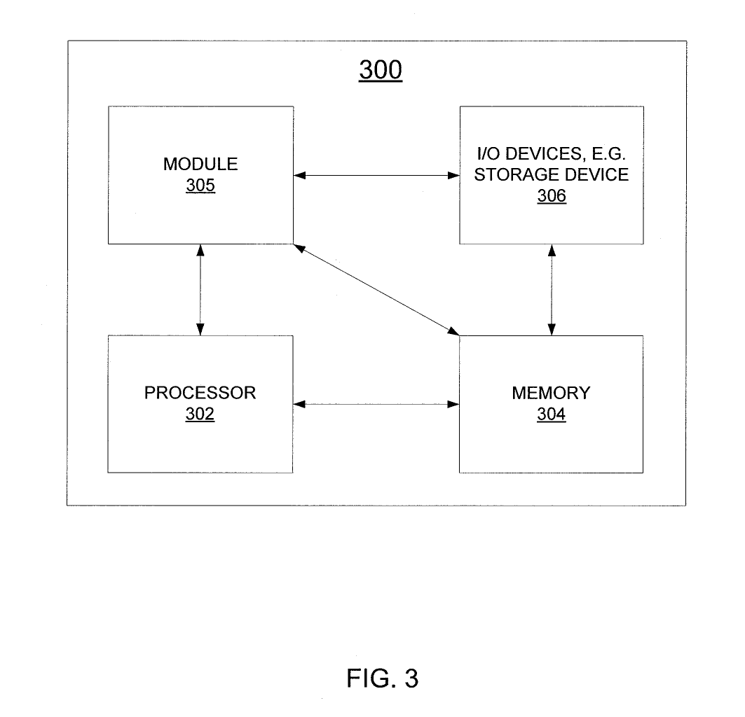

To better understand the present disclosure, FIG. 1 illustrates an example system 100, suitable for implementing embodiments of the present disclosure. The system 100 includes a communication network 130 interconnecting several devices associated with various entities. Several of the devices of system 100 may be referred to herein as servers. In general, a server is a hardware machine or computer that is well known in the art and may be configured to perform various functions as described herein. For example, a server, in accordance with various embodiments, may take the form of a general purpose computer (e.g., computer 300 as shown in FIG. 3) specifically configured to perform various functions as described herein. Communication network 130 may comprise any packet switched or circuit switched network, or any combination of such networks, e.g., Internet Protocol (IP) networks, wireless networks, Asynchronous Transfer Mode (ATM) networks, Frame Relay networks, and the like. For example, communication network 130 may comprise the Internet, one or more wired, wireless or fiber optic networks, one or more access networks, cellular networks, metropolitan area networks (MANs), wide area networks (WANs), local area networks (LANs) and/or core networks to support communications between and among devices connected via the communication network 130.

Notably, the system 100 may also include a social network site 101, controlled by a social network provider or operator. The social network site 101 may comprise at least one server, or a group of servers at a single location or distributed locations connected to the communication network 130. In one embodiment, the social network site 101, via the one or more servers, provides a social network website and associated database(s) 112 for storing user profile data, social network usage data and other metrics pertaining to the social network. In various embodiments, the social network site 101 also includes an authentication and billing system 111 which may reside on one or more distributed or co-located servers at one or more locations of the social network site.

The system 100 may also include at least one third-party device 102. In one embodiment, third party device 102 may comprise one or more servers, such as: web server(s), and search engine servers, hosting various services and functions. Thus, third party device 102 may be a single server, controlled by a single entity, or may comprise separate devices (e.g., different servers, computers, etc.) hosted or maintained by the single entity, or a number of different entities.

In various embodiments, system 100 further includes at least one ad-agent 103. In one embodiment, ad-agent 103 comprises one or more advertising servers for generating and providing advertising content. For example, a web-site hosted on third-party device 102 may provide web-pages having advertising portions thereon, wherein the advertising is provided by a third party advertising server (e.g., ad-agent 103). Similarly, the social network may host advertisements on the social network site (e.g., on one or more pages of a website of the social network) for one or more advertisers, each of which may have its own advertising server(s) which may comprise ad-agent(s) 103.

The exemplary system 100 may also include one or more user devices 121 for interfacing user(s) 104 with the communication network 130, social network site 101, and/or third party device(s) 102. In various embodiments, the user devices 121 may comprise a personal computer, a smart phone, a cellular phone, a computing tablet, a Wi-Fi device, an Internet Protocol television (IPTV) and/or set-top box, or any type of endpoint device configured for network-based communication.

Although the above described components and functions have been referred to with particular terms, it should be understood that the particular terms and embodiments depicted in FIG.1 and described above are not the only embodiments of the present disclosure. Accordingly, it should be understood that other components and the terminology used to refer to such components may be used interchangeably with those depicted and described in connection with FIG. 1, depending upon the context and/or the particular network. For example, although the elements comprising the system 100 have been described as one or more discrete devices, the depicted arrangement is merely illustrative of one configuration that is suitable for implementing embodiments of the present disclosure. Thus, any other element or elements providing the same functionality described herein with respect to the user devices 121, communication network 130, third party device(s) 102, ad-agent 103 or social network site 101 would be equally suitable for use in accordance with embodiments of the present disclosure. For example, it should be realized that the system 100 may be expanded by including additional third party devices, ad-agents, social networks, etc., without altering the scope of the present disclosure. Accordingly, the foregoing is provided as an illustrative example only.

The system 100 of FIG. 1 is described to provide an illustrative environment in which advertising can be provided to users and in which users' values can be determined within a social network. Thus, the current disclosure discloses a method, computer readable medium and apparatus for determining a value of a user of a social network in an exemplary system illustrated in FIG. 1, and as described further below.

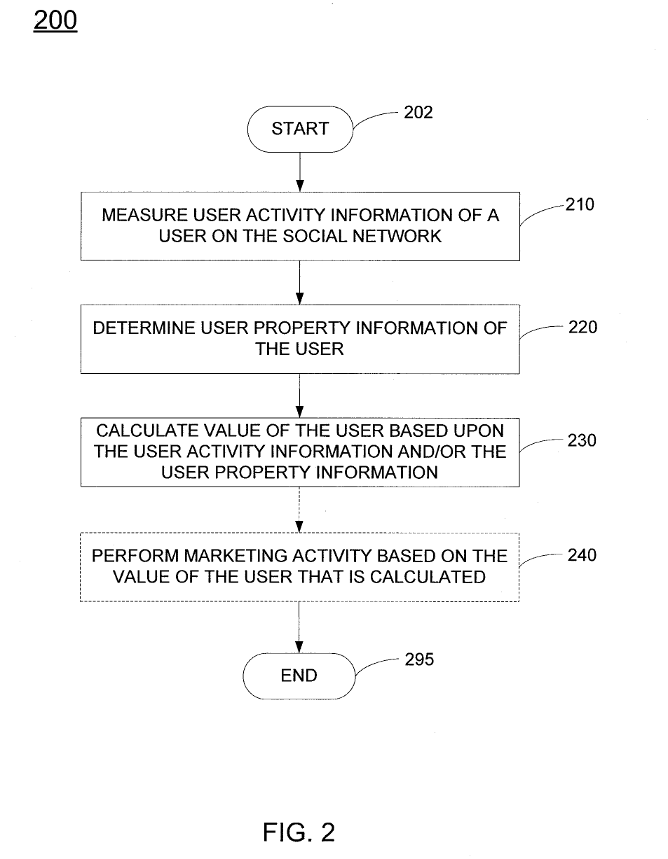

FIG. 2 illustrates a flowchart of a method 200 for determining a value of a user of a social network. The steps or operations of the method 200 may be performed by any one or more of the components of the system 100 depicted in FIG. 1. For example, one or more operations of the method 200 may be implemented by a social network site (e.g., one or more social network servers). Alternatively, or in addition, one or more operations of the method 200 may be implemented by a general purpose computer having a hardware processor, a memory and input/output devices as illustrated below in FIG. 3. Although any one of the elements in system 100 may either singly, or in conjunction with any one or more of the other elements, be configured to perform various steps or operations of the method 200, for illustrative purposes only, the method will now be described in terms of an embodiment where operations of the method are performed at a social network site via one or more servers, such as social network site 101 in FIG. 1.

The method 200 begins in step 202 and proceeds to step 210.

At step 210, the method 200 measures user activity of a user on a social network. For instance, the user activity information may comprise an uploading of user profile information to a user profile of the user on the social network, a liking of an object (broadly representing an endorsement of the object), an acceptance of a friend request, and/or an uploading of content to the social network, e.g., to a database and/or server of the social network. In one embodiment, the user activity information is directly measurable via the interactions between a device of the user and one or more servers of the social network. For instance, if a user uploads content, there may be a number of communications between the user's device and one or more servers of the social network server in order to complete the uploading of the content, e.g., to a database maintained by the social network. Various other user activities as described above may also be observable by the social network in the same manner.

In one embodiment, user activities may relate to actions that involve third parties (e.g., a third-party's website and/or web-server, such as one of the web servers 102 in FIG. 1). For example, a user may be browsing news articles on a website of a news organization. In addition, one or more news articles may have a “Like” button or similar mechanism for the user to select. Notably, the action of the user “Liking” an article (broadly referred to as providing a user opinion) by selecting the “Like” button may cause this action to be conveyed back to the social network. For instance, the news organization and the social network operator may have an arrangement whereby the news organization provides user activity information to the social network operator. In one embodiment, the use of “Like” buttons on a third-party website, or other interactions with the third-party website may automatically cause usage information to be provided back to the social network. As such, in some cases user activity information may be measured with respect to the user's activities on the social network as well the user's other online activities.

In one embodiment, at step 210 the method 200 further quantifies the user activity information for later use in calculating a value of the user. For example, the method 200 may keep a running count of the number of content items uploaded by a user. In one embodiment, the method may count the number of items uploaded (or other user activity or activities being measured) within a given time period (e.g., within the last week, the last month, the last quarter and so on) in order to keep current with calculations of the value of the user. In particular, the value of the user may be more depended on the recent activity of the user, as opposed to activities occurring in the past.

In addition, in one embodiment, at step 210 the method 200 further quantifies indirect activities that are attributable to an activity of the user. For example, a user may upload a video, photograph or other content to the social network. Thereafter, a number of other users may then access and view the content, with each view potentially generating one or more additional advertisement views. Accordingly, the method 200 may measure the one or more subsequent view of the content uploaded by the user. This quantity of indirect activity may then be further used to calculate the value of the user at step 230 discussed below. Similarly, in another embodiment the user activity may comprise recruiting a new user. As such, indirect activity may include the new user recruiting subsequent new users. This activity may be tracked and later used to adjust the value of the original user. For instance, the original user may get a partial “credit” for the subsequent recruitment of users by the new user.

At optional step 220, the method 200 may also determine user property information, e.g., one or more user properties, of the user. For example, the method 200 may obtain profile information of the user in order to determine one or more of the user properties. In one embodiment, the user properties may include any one or more of: a number of friends of the user on the social network, a number of group memberships of the user on the social network, a participation time of the user on the social network, a quantity of content uploaded to the social network by the user for a given period of time and a number of new users that the user has recruited on the social network. In one embodiment, various user properties may be determined by obtaining a user profile of the user. For instance, the method 200 may retrieve a user profile or other information relating to the user that may be stored in one or more databases on one or more servers maintained by the social network. The user profile may include various information pertaining to the user, including but not limited to: the user's contact information, demographic information, username, password, security questions, security answers, privacy settings and the like. In addition, the user profile may include other information/user properties including but not limited to: one or more lists of friends, families, colleagues, acquaintances, and the like, self-described interests of the user, interests of the user as inferred by the social network, groups in which the user is a member or with which the user is associated, public and private user content, such as photographs, journal postings, and other content that has been created and/or uploaded by the user, native applications and third-party applications that are accessible to the user (e.g., that are purchased, downloaded and/or used by the user or installed on one or more devices of the user), and historical data pertaining to past and current usage of the social network by the user. In one embodiment, the historical data may comprise a time of use on the social network, a time of use of native applications, a time of use of third-party applications, a list of all content items viewed by the user or uploaded by the user, etc. It should be noted that a “time of use” can be measured with respect to a start time (e.g., a time when an application is activated) for an application and an end time for the application (e.g., a time when the user simply finishes interacting with the application). It should be noted that any other methods for computing a “time of use” is within the scope of the present disclosure.

In one embodiment, at step 220 the method 200 further quantifies the one or more user properties that are determined. For instance, the method 200 may note the number of content items that are uploaded by the user, e.g., the user has uploaded 200 photographs, has made 70 journal entries, has comment on friends' postings 350 times, and has “Liked” 400 content items. The method 200 may also note the quantity of time the user has spent on the social network, e.g., 100 hours logged-in to the social network which may include, e.g., 25 hours using native applications, 30 hours using third-party applications, and the like. The method 200 may also note the number of groups in which the user is a member, e.g., the number of contacts in one or more lists (e.g., friends, family, colleagues), and the like. In one embodiment, the method 200 quantifies the user properties only with respect to a particular time period, e.g., only activities or information pertaining to the last 30 days, the last three months, and so forth. It should also be noted that in some cases, the activities of the user that may be measured at step 210 may also impact any one or more user properties that may be determined at step 220. For instance, a user may perform the action of accepting a new friend request. In turn, this action will also increase the user property information of “number of friends” that may be measured at step 220.

At step 230, the method 200 calculates a value of the user based upon the user activity information and/or the user properties that are measured and determined at steps 210 and 220, respectively. For example, the method 200 may apply a formula to the quantities or values pertaining to each of the user activities and user properties for which information is gathered at steps 210 and/or 220, respectively. As an example, the method 200 may have measured that a user has uploaded five items of user profile information into the user's profile, “Liked” 90 content items, accepted six friend requests, and uploaded 30 content items (e.g., in the last month, or other relevant time period). Accordingly, the method 200 may enter such quantities into a formula of V=aX+bY+cZ+dW+e, where V is the user value, X is the number of items of user profile information added by the user, Y is the number of “Likes” made by the user, Z is the number of friend requests accepted by the user and W is the number or quantity of content items uploaded by the user. In one embodiment, the items “a”-“e” are constants (broadly weights) which may be selected (e.g., by an operator of the Online Social Network) to fulfill various criteria, e.g., business objectives. For example, the social network operator may deem the number of content items uploaded to have much greater significance in terms of user value than the quantity of user profile information uploaded. As such, item “d” may be a constant that is much greater than a constant “a”. It should be noted that this is only one example of a formula that may be implemented by the method 200 at step 230 in order to calculate the user value. For instance, “a”-“e” may not comprise constants, but may be variables that will change based upon any number of factors such as a time of day, relative scores of other users, a geographic area in which the user is located, a proximity of the user to a certain event, etc. In one embodiment, a dynamic formula is used whereby “a”-“e” may change based upon observational results of subsequent marketing and advertising activities.

At step 230, the method 200 may additionally factor in one or more user properties that are determined at step 220 in calculating the value of the user. For instance, the formula described above for calculating V may be extended to include at least one user property information as V=aX+bY+cZ+dW+e+fG, where f is a constant or other modifier that is selected (e.g., by an operator of the social network) and G is a quantity of that at least one user property information that is determined at step 220. The foregoing is an example of extending such a formula to account for only one additional user property. However, any number of additional user properties may be accounted for, e.g., by extending the formula in a similar fashion. In addition, it should be noted that the foregoing formula is only one example of how an overall user value may be calculated. As such, different OSNs may use various different formulas to fulfill various objectives. In other words, the present disclosure is not limited to any particular formula or equation. Thus, the foregoing is provided by way of example only and not limitation. In any case, step 230 results in the calculation of an overall score or value of the user that is generally indicative of the value of the user to the social network.

At optional step 240, the method 200 performs a marketing activity based upon the value of the user that is calculated at step 230. For instance, an advertiser may wish to target advertisements to users of the social network. However, the advertiser may desire to have a large number of ad impressions within a relatively short period of time. As such, the method 200 may determine that it would be most effective to primarily target high value users of the social network first. For example, the presumed ability of the high value users to generate a large number of additional impressions, i.e., indirect impressions, may serve the goal of the advertiser to achieve a high number of impressions very quickly. As such, the method 200 may select a list of high value users (e.g., with user values/scores above a particular threshold) and target such users with the advertisements on behalf of an advertiser. In one embodiment, the method 200 may attach the advertisements to the content uploaded by the high valued users, such that the advertisements are displayed when others who are connected to the user view such content, etc. In one embodiment, an advertiser may wish to offer more significant discounts or provide a special offer that is available only to high value (e.g., well connected) users. Accordingly, the method 200 may select a set of high value users and deliver the offer or other advertisements of the advertiser through links, banners, messages, emails and the like to such high value users. However, this service may be provided in exchange for a relatively greater payment from the advertiser as compared to the fee for general or random access to the users for advertising. In one embodiment, the method 200 may provide a list of high valued users to one or more advertisers such that the advertiser can perform marketing activities via its own systems. For instance, the advertiser may select different advertisements to be placed for high valued users on one or more third-party websites as the high value users may engage in online activities, e.g., web browsing through such one or more third-party websites. In still another embodiment, the social network may provide additional rewards or incentives to high valued users such as access to premium content, features or services for free or for a discount, coupons, credits or other awards, and so forth. It should be noted that the foregoing are only several examples of marketing activities that may be performed at step 240. As such, various other marketing activities may be provided at step 240 in accordance with embodiments of the present disclosure.

Following step 240, the method 200 proceeds to step 295 where the method ends.

In addition, although not expressly specified above, one or more steps/operations/functions of method 200 may include a storing, displaying and/or outputting step/operations/function as required for a particular application. In other words, any data, records, fields, and/or intermediate results discussed in the method can be stored, displayed and/or outputted to another device as required for a particular application. Furthermore, operations, steps or blocks in FIG. 2 that recite a determining operation or involve a decision do not necessarily require that both branches of the determining operation be practiced. In other words, one of the branches of the determining operation can be deemed as an optional step. Furthermore, operations, steps or blocks of the above described methods can be combined, separated, and/or performed in a different order from that described above, without departing from the example embodiments of the present disclosure.

FIG. 3 depicts a high level block diagram of a general purpose computer suitable for use in performing the functions described herein. For examples, any one or more components or devices illustrated in FIG. 1 or described in connection with the method 200 may be implemented as the system 300. As depicted in FIG. 3, the system 300 comprises a hardware processor element 302 (e.g., a microprocessor, a central processing unit (CPU) and the like), a memory 304, e.g., random access memory (RAM) and/or read only memory (ROM), a module 305 for determining a value of a user of a social network, and various input/output devices 306 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that embodiments of the present disclosure can be implemented in software and/or in a combination of software and hardware, e.g., using application specific integrated circuits (ASIC), a general purpose computer or any other hardware equivalents, e.g., computer readable instructions pertaining to the method(s) discussed above can be used to configure a hardware processor to perform the steps, functions and/or operations of the above disclosed method. In one embodiment, the present module or process 305 for determining a value of a user of a social network can be implemented as computer-executable instructions (e.g., a software program comprising computer-executable instructions) and loaded into memory 304 and executed by hardware processor 302 to implement the functions as discussed above in connection with the exemplary method 200. As such, the present module or process 305 for determining a value of a user of a social network as discussed above in method 200 (including associated data structures) can be stored on a non-transitory (e.g., tangible or physical) computer readable storage medium, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for determining a value of a user of a social network, comprising:
measuring, by a processor, user influence information of the user on the social network; and
calculating, by the processor, the value of the user based upon the user influence information.

2. The method of claim 1, wherein the user influence information comprises user activity information, wherein the user activity information comprises:
an uploading of user profile information to a user profile of the user on the social network;
an endorsement of an object;
an acceptance of a friend request; and
an uploading of content to the social network.

3. The method of claim 1, wherein the user influence information comprises user property information, wherein the calculating the value of the user is further based upon the user property information.

4. The method of claim 3, wherein the user property information comprises:
a number of friends of the user on the social network;
a number of group memberships of the user on the social network;
a participation time of the user on the social network;
a quantity of content uploaded to the social network by the user; and
a number of new users that the user has recruited to the social network.

5. The method of claim 3, wherein the user property information comprises:
a time of use of social network-native applications by the user.

6. The method of claim 3, wherein the user property information comprises:
a number of third-party applications accessible to the user.

7. The method of claim 6, wherein the user property information further comprises:
a time of use of the third-party applications by the user.

8. The method of claim 3, wherein the user property information comprises:
a quantity of indirect activities attributable to an activity of the user.

9. The method of claim 8, wherein the activity of the user comprises an uploading of content to the social network.

10. The method of claim 8, wherein one indirect activity of the indirect activities comprises a different user commenting on the content that is uploaded to the social network.

11. The method of claim 8, wherein one indirect activity of the indirect activities comprises a different user commenting on a response related to the content that is uploaded.

12. The method of claim 9, wherein the activity of the user comprises an uploading of profile information of the user.

13. The method of claim 1, further comprising:
performing a marketing activity based upon the value of the user that is calculated.

14. A tangible computer-readable medium storing instructions which, when executed by a processor, cause the processor to perform operations for determining a value of a user of a social network, the operations comprising:
measuring, by a processor, user influence information of the user on the social network; and
calculating, by the processor, the value of the user based upon the user influence information.

15. The tangible computer-readable medium of claim 14, wherein the user influence information comprises user activity information, wherein the user activity information comprises:
an uploading of user profile information to a user profile of the user on the social network;
an endorsement of an object;
an acceptance of a friend request; and
an uploading of content to the social network.

16. The tangible computer-readable medium of claim 14, wherein the user influence information comprises user property information, wherein the calculating the value of the user is further based upon the user property information.

17. The tangible computer-readable medium of claim 16, wherein the user property information comprises:
a number of friends of the user on the social network;
a number of group memberships of the user on the social network;
a participation time of the user on the social network;
a quantity of content uploaded to the social network by the user; and
a number of new users that the user has recruited to the social network.

18. The tangible computer-readable medium of claim 16, wherein the user property information comprises:
a time of use of social network-native applications by the user.

19. The tangible computer-readable medium of claim 16, wherein the user property information comprises:
a number of third-party applications accessible to the user.

20. An apparatus for determining a value of a user of a social network, comprising:
a processor; and
a computer-readable medium in communication with the processor, storing instructions which, when executed by the processor, cause the processor to perform operations, the operations comprising:
measuring, by a processor, user influence information of the user on the social network; and
calculating, by the processor, the value of the user based upon the user influence information.
